(19) United States
(12) Patent Application Publication
(10) Pub. No.: US 2015/0058201 A1
(43) Pub. Date: Feb. 26, 2015

(54) ELECTRONIC BOOK STREAMING SERVICE

(71) Applicant: KT Corporation, Seongnam-si (KR)

(72) Inventor: Young-sam CHUN, Seoul (KR)

(21) Appl. No.: 14/463,128

(22) Filed: Aug. 19, 2014

(30) Foreign Application Priority Data
Aug. 23, 2013 (KR) 10-2013-0100683

(51) Int. Cl. G06Q 20/12

(52) U.S. Cl. CPC G06Q 20/123
USPC 705/39

(57) ABSTRACT

In one example embodiment, a server includes a content transmitter configured to transmit e-book content to an end device that displays e-book content; a compiler configured to analyze e-book reading patterns on the end device; a session manager configured to: divide the e-book content into a plurality of reading sessions, and determine a stopping point for a current one of the reading sessions, based on past reading pattern data included in the reading patterns of the end device; and a charge manager configured to charge a fee for the current reading session, when the current reading session reaches the determined stopping point.

### TECHNICAL FIELD

The embodiments described herein pertain generally to streaming electronic book content.

### BACKGROUND

An electronic book (E-book) is generically known as a digital book. More particularly, publications or books may be recorded in an electronic recording medium or remote storage device, from which users may gain access via computers or portable terminals.

### SUMMARY

In one example embodiment, a server may include a content transmitter configured to transmit e-book content to an end device that displays e-book content and a compiler configured to analyze e-book reading patterns on the end device; the server may also include a session manager configured to: divide the e-book content into a plurality of reading sessions, and determine a stopping point for a current one of the reading sessions based on past reading pattern data included in the reading patterns of the end device. The server may also include a charge manager configured to charge a fee for the current reading session, when the current reading session reaches the determined stopping point.

In another example embodiment, a method performed under control of a server may include: dividing e-book content into a plurality of reading sessions; transmitting, to an end device that displays e-book content, e-book content for a requested one of the plurality of reading sessions; analyzing reading patterns on the end device; determining a stopping point for the requested reading session on the end device, based on past reading pattern data included in the reading patterns of the end device; and charging a fee for the requested reading session, when the requested reading session reaches the determined stopping point.

In yet another example embodiment, a computer-readable storage medium may store thereon computer-executable instructions that, in response to execution, cause a server to perform operations including: dividing e-book content into a plurality of reading sessions; transmitting, to an end device that displays the e-book content, e-book content for a requested one of the plurality of reading sessions; analyzing reading patterns on the end device; determining a stopping point for the requested reading session based on past reading pattern data included in the reading patterns of the end device; and charging a fee for the requested reading session, when the requested reading session reaches the determined stopping point.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which an electronic book streaming service may be implemented, in accordance with various embodiments described herein;

FIG. 2A shows an example end device by which at least portions of an electronic book streaming service may be implemented, in accordance with various embodiments described herein;

FIG. 2B shows another example end device by which at least portions of an electronic book streaming service may be implemented, in accordance with various embodiments described herein;

FIG. 3A shows an example timeline that depicts electronic book reading sessions as divided by an electronic book streaming service, in accordance with various embodiments described herein;

FIG. 3B shows another example timeline that depicts electronic book reading sessions as divided by an electronic book streaming service, in accordance with various embodiments described herein;

FIG. 3C shows yet another example timeline that depicts electronic book reading sessions as divided by an electronic book streaming service, in accordance with various embodiments described herein;

FIG. 4 shows an example server by which at least portions of an electronic book streaming service may be implemented, in accordance with various embodiments described herein;

FIG. 5 shows an example processing flow of operations by which at least portions of an electronic book streaming service may be implemented, in accordance with various embodiments described herein;

FIG. 6 shows another example processing flow of operations by which at least portions of an electronic book streaming service may be implemented, in accordance with various embodiments described herein;

FIG. 7 shows yet another example processing flow of operations by which at least portions of an electronic book streaming service may be implemented, in accordance with various embodiments described herein; and

FIG. 8 shows an illustrative computing embodiment, in which any of the processes and sub-processes of an electronic book streaming service may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

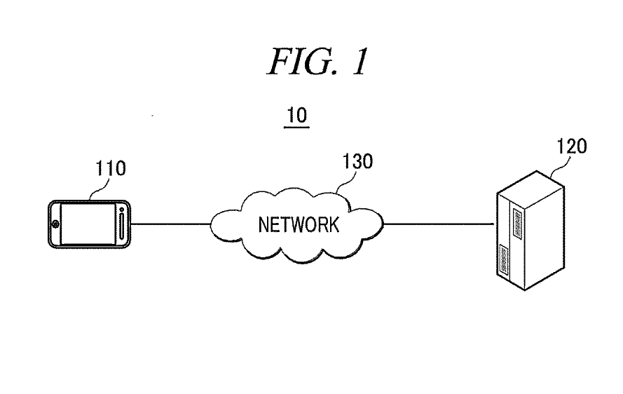

FIG. 1 shows an example system 10 in which an electronic book streaming service may be implemented, in accordance with various embodiments described herein. As depicted in FIG. 1, system 10 may include, at least, an end device 110 and a server 120. End device 110 and server 120 may be communicatively connected to each other via a network 130.

End device 110, as non-limiting examples, may refer to a notebook computer, a personal computer, a smart phone, a tablet computer, a phablet device, a smart television, or other personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal.

Server 120 may refer to one or more servers, processing apparatuses, or computing devices hosted and/or supported by a service provider that may be configured to transmit electronic book content to multiple end devices, including end device 110. Server 120 may also be configured to divide the electronic book content into multiple reading sessions; to transmit the content for one or more of the divided reading sessions to end device 110; and to charge a fee for the transmitted reading sessions.

In some embodiments, end device 110 may be configured to transmit, to server 120, a request for electronic book content. The electronic book content may include one or more text files, and further include at least one of video files, audio files or image files.

In some embodiments, server 120 may be configured to divide the electronic book content into multiple reading sessions, based on criteria that included, but are not limited to, an evaluation or analysis of at least one of topical content or chapters of the electronic book content. For example, server 120 may identify and/or determine the number of chapters of the electronic book using known text recognition technologies. Thus, server 120 may divide the electronic book content for each of the multiple reading sessions into an equal number of chapters (e.g., each reading session of the electronic book content includes two chapters). As described herein, the electronic book content may also include video and/or audio content; therefore, a reading session, in accordance with the embodiments described herein, may also refer to playing time of such content. Playing time may refer to an amount of time to view such video content and/or listen to such audio content, as divided for a respective “reading session.”

In some embodiments, as referenced herein, electronic book content corresponding to a reading session may include text files or image files that are displayable on end device 110. Non-limiting examples of a reading session may include one chapter of the electronic book content.

In other embodiments, as referenced above, any one of the reading sessions of the electronic book content may also refer to a part of the electronic book content, e.g., video and/or audio files, for which playing time may be divided. Thus, server 120 may be configured to divide the electronic book content into multiple reading sessions, based on a playing time of one or more video files and/or audio files that may be included in the electronic book content, in addition to the aforementioned criteria of topics, length (e.g., chapters), or even time. For example, server 120 may divide the electronic book content, so that the playing time of video files and/or audio files included in each of the multiple reading sessions is substantially equal (e.g., the video files and/or audio files in each reading session has a playing time of approximately one minute).

Server 120 may be configured to transmit, to end device 110, a requested reading session of the electronic book content. For example, server 120 may stream, to end device 110, two chapters of the electronic book content as a requested reading session of the electronic book content. Additionally or alternatively, server 120 may stream, to end device 110, approximately one minute of playing time of video files, audio files, and/or image files that may be included in a reading session of the electronic book content.

In some embodiments, server 120 may be configured to determine which files are to be transmitted to end device 110, based on a type of end device 110. Server 120 may identify a type of end device 110, e.g., a smart phone or an e-book reader (e.g., Kindle®), based on an identifier or a serial number that is assigned to end device 110. Thus, server 120 may identify and/or determine types of files (e.g., text, video, audio, or image) that may be suitable for end device 110, based on the identified type or functions of end device 110. For example, server 120 may transmit, to end device 110, text files as well as video files that may be included in a reading session of the electronic book content, if end device 110 is a smart phone that is capable of playing video files. As another example, server 120 may transmit, to end device 110, text files and/or image files that may be included in a reading session of the electronic book content, if end device 110 is a device that is not capable of playing video files, e.g., if software that enables video files to be played is not installed on end device 110 or if software or hardware installed on end device 110 is not compatible with video files associated with the electronic book content.

In some other embodiments, server 120 may be configured to transmit, to end device 110, at least one of the one or more video files, audio files, and/or image files that may be included in a reading session of the electronic book content based on a user preference. Information regarding the user preference may be pre-learned or pre-registered in server 120 in association with user account authenticated on end device 110. For example, server 120 may transmit, to end device 110, audio files that may be included in a reading session of the electronic book content when a profile associated with a user account registered on end device 110 indicates a preference to listen to audio files as opposed to reading a text display.

Server 120 may also be configured to measure a required time for end device 110 to display a page of a text files that may be included in a reading session of the electronic book content on end device 110. In some embodiments, server 120 may be configured to receive, from end device 110, time information regarding an amount of time that the text page of the reading session of the electronic book content has been displayed on end device 110. Server 120 may be further configured to measure the required time from the received time information. In some other embodiments, server 120 may be configured to measure and/or calculate an amount of time for streaming a text page of the reading session of the electronic book content to end device 110, and to identify the measured or calculated amount of time as the required time.

Server 120 may be further configured to analyze reading patterns on end device 110, based on the measured required time. In some embodiments, server 120 may be configured to generate past reading pattern data of end device 110, which may include an average amount of time for a user of end device 110 to read a page of the electronic book content, from the measured required time. Further, server 120 may be configured to identify the past reading pattern data as the reading patterns of end device 110. Server 120 may be further configured to determine or identify that a user of end device 110 has a relatively fast reading speed or a relatively slow reading speed, based on the reading patterns of end device 110.

Further, server 120 may be configured to analyze the reading patterns of end device 110 and/or a user account associated with the owner and/or operator of end device 110, and to store the past reading pattern data of end device 110, based on a type or genre of electronic book content. For example, the past reading pattern data of end device 110 may include a genre (e.g., romance) of electronic book content that has been provided to end device 110. Further, the past reading pattern data of end device 110 may include a number of times that respective genres (e.g., romance or mystery) of electronic book content have been provided to end device 110. Server 120 may determine or identify the genre of the electronic book content that a user of end device 110 prefers (e.g., romance), based on the reading patterns of end device 110.

Server 120 may be configured to determine and/or predict a stopping point for a current reading session of the electronic book content on end device 110, based on the past reading pattern data that is included in the reading patterns of end device 110. As referenced herein, the current reading session may be a reading session of the electronic book content that is currently being displayed on end device 110. For example, server 120 may recommend and transmit, to end device 110, a reading session of electronic book content that includes video files and/or audio files for the user's preferred genre (e.g., romance) when server 120 receives, from end device 110, a request for electronic book content. Server 120 may be further configured to stop the current reading session (i.e., the reading session that includes video files or audio files for romance), if server 120 receives, from end device 110, a request for a reading session that includes video files or audio files for humor, e.g., comics or satire.

In some embodiments, server 120 may be configured to determine a stopping point for a current reading session of the electronic book content on end device 110, based on playing settings of the video files or the audio files that are included in the session of the electronic book content. Server 120 may stop the current reading session of the electronic book content, when the playing settings of the video files or audio files that correspond to the current reading session change. Server 120 may further start another reading session that corresponds to video files or audio files which have the changed playing settings. For example, the playing settings may include a playing quality or condition of the video files or audio files. The playing quality or condition may include at least one of two-dimensions (2D), three-dimensions (3D), standard definition (SD), high definition (HD) or stereo. For example, if a resolution of video files is changed from two-dimensions to three-dimensions, server 120 may be configured to stop the current reading session which has two-dimensional video files, and to start a new reading session which has three-dimensional video files.

As yet another example, the playing settings of the electronic book content on end device 110 may refer to physical context of end device 110. For example, the physical context of end device 110 may include a type of network 130 or a type of end device 110. For example, if the type of network 130 is changed from 3G to Wi-Fi, server 120 may be configured to stop the reading session that has been being facilitated via the 3G network, and to start a new session via the Wi-Fi network.

In some embodiments, server 120 may be configured to determine a stopping point for a current reading session of the electronic book content on end device 110 based on conclusions of at least one of topical content or chapters. For example, when a chapter of the electronic book content to be displayed at end device 110 transitions from one chapter to another chapter, server 120 may be configured to stop the reading session that corresponds to the just-completed chapter, and to start a new reading session which corresponds to the subsequent chapter.

In some embodiments, server 120 may be configured to determine a stopping point for a current reading session of the electronic book content on end device 110 based on passage of a predetermined time period. Server 120 may be configured to maintain the reading session of the electronic book content within the predetermined time period, even if a chapter of the electronic book content to be reproduced at end device 110 transitions from one chapter to another.

In some embodiments, server 120 may be configured to determine a stopping point for a current reading session of the electronic book content on end device 110 based on a number of remaining authorized reading sessions for the electronic book content. A user of end device 110 may purchase a number of authorized sessions, and user rights for the authorized sessions may be assigned to end device 110 or a user account associated with the owner and/or operator of end device 110. Server 120 may be configured to monitor the remaining authorized sessions for the electronic book content. Further, server 120 may be configured to stop the reading session of the electronic book content on end device 110 if there are no remaining authorized user rights to play the electronic book content.

In some embodiments, server 120 may be configured to determine a stopping point for a current reading session of the electronic book content on end device 110 based on a current location of end device 110. Server 120 may be configured to receive, from end device 110, location information of end device 110, such as GPS (Global Positioning System) coordinates. Further, for example, server 120 may be configured to stop the current reading session of the electronic book content on end device 110 if end device 110 moves to a location, e.g., a valley, in which streaming of the electronic book content is limited or unavailable due to a poor network connection. Thus, if streaming of the current reading sessions is stopped by a matter of poor network reception, server 120 may identify the stopping point for the stopped reading session as being the time when the streaming of the current reading sessions ended.

In some embodiments, server 120 may be configured to transmit, to end device 110, a message that may indicate that the reading session of the electronic book content has ended.

Server 120 may be configured to charge a fee for the reading session of the electronic book content to a user account associated with the owner and/or operator of end device 110, when the reading session reaches the determined stopping point. In some embodiments, server 120 may be configured to monitor a number of remaining authorized reading sessions of the electronic book content that may be associated with the user account associated with the owner and/or operator of end device 110. Further, server 120 may be configured to deduct the authorized numbers of reading sessions of the electronic book content as for the fee for the reading session.

In some embodiments, server 120 may be configured to determine the fee for the reading session of the electronic book content, based on the playing settings of the video files or audio files that may be included in the reading session. If the resolution of the video files that corresponds to the reading session is three-dimensional (3D), server 120 may be charge a relatively high fee. Further, if the resolution of the video files that correspond to the reading session is two-dimensional (2D), server 120 may be charge a fee that is less than that of the three-dimensional session of the electronic book content.

In some embodiments, server 120 may be configured to charge the fee for the reading session of the electronic book content to other user account associated with an owner and/or operator of another end device on behalf of the user account associated with end device 110 when end device 110 received user rights for the electronic book content from the other end device. For example, if the other user account associated with the owner and/or operator of the other end device has user rights to play the electronic book content ten times and if the user account associated with the owner and/or operator of end device 110 received, from the other end device, the user rights to play the electronic book content one time, server 120 may be configured to deduct the user rights that are assigned to the other user account associated with the owner and/or operator of the other end device as for the fee for the reading session of the electronic book content.

Network 130 may include, as non-limiting examples, a wireless network such as a mobile radio communication network including at least one of a 3rd generation (3G), 4^{th} generation (4G), or 5^{th} generation (5G) mobile telecommunications network, various other mobile telecommunications networks, a satellite network, WiBro, Mobile WiMAX (World Interoperability for Microwave Access), HSDPA (High Speed Downlink Packet Access), Bluetooth, or the like.

Thus, FIG. 1 shows an example system 10 in which an electronic book streaming service may be implemented, in accordance with various embodiments described herein.

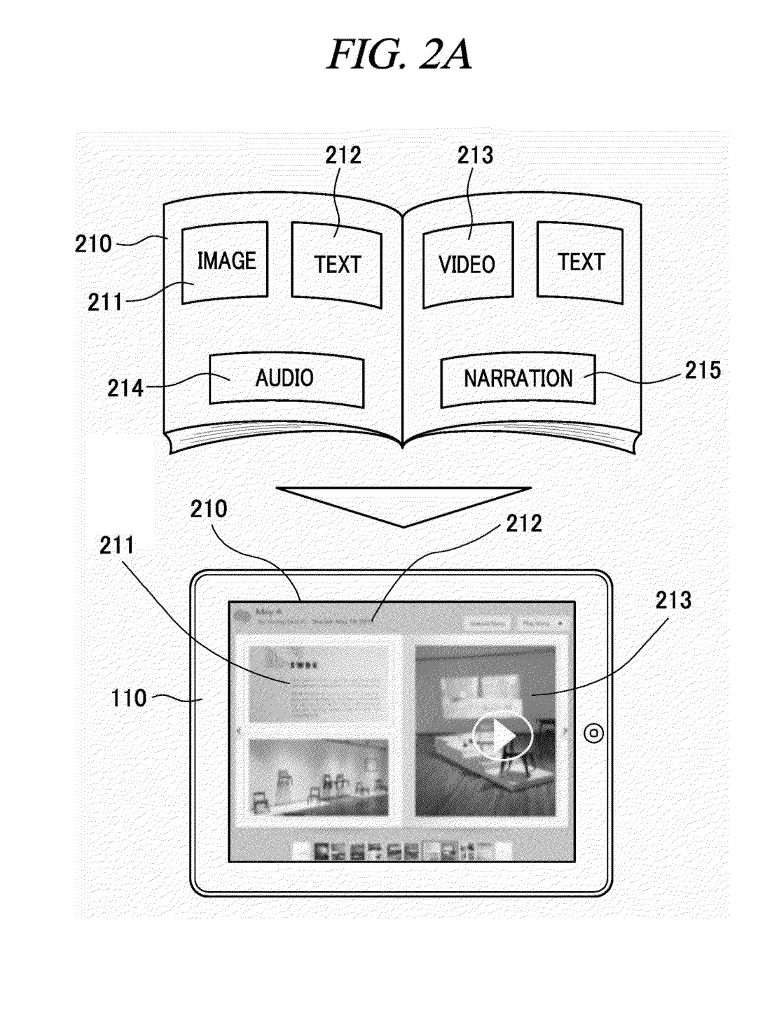

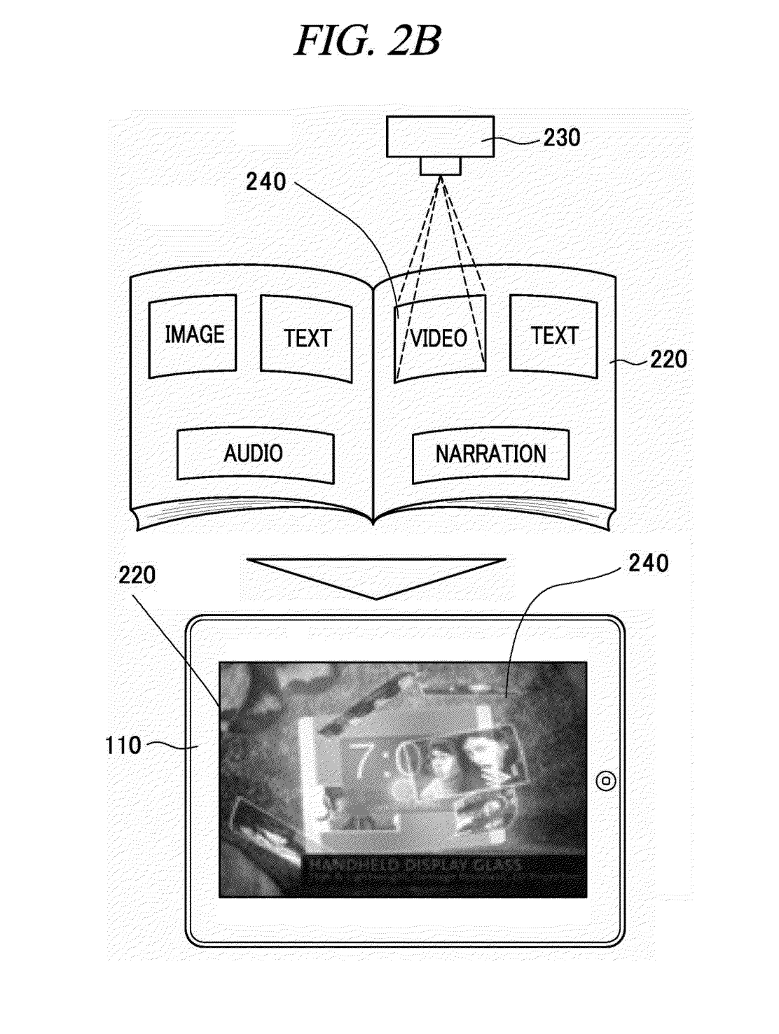

FIG. 2A shows an example end device by which at least portions of an electronic book streaming service may be implemented, in accordance with various embodiments described herein. As depicted in FIG. 2A, end device 110 may be configured to display two dimensional (2D) electronic book content 210. Electronic book content 210 may include one or more image components 211, text components 212, video components 213, audio components 214 and/or narration 215. Image files corresponding to image components 211, text files corresponding to text components 212, video files corresponding to video components 213, and audio files corresponding to audio components 214 may be inserted in electronic book content 210.

FIG. 2B shows another example end device by which at least portions of an electronic book streaming service may be implemented, in accordance with various embodiments described herein. As depicted in FIG. 2B, end device 110 may be configured to display three dimensional (3D) electronic book content 220. Electronic book content 220 may include one or more three dimensional image components or video components 240. Further, three dimensional images or video 240 may be displayed on end device 110 by a three dimensional image displaying device 230, such as a beam projector, which is communicatively coupled to end device 110. For example, three dimensional image displaying device 230 may be configured to project beam or hologram on end device 110.

Thus, FIG. 2A shows an example end device by which at least portions of an electronic book streaming service may be implemented, in accordance with various embodiments described herein. Further, FIG. 2B shows another example end device by which at least portions of an electronic book streaming service may be implemented, in accordance with various embodiments described herein.

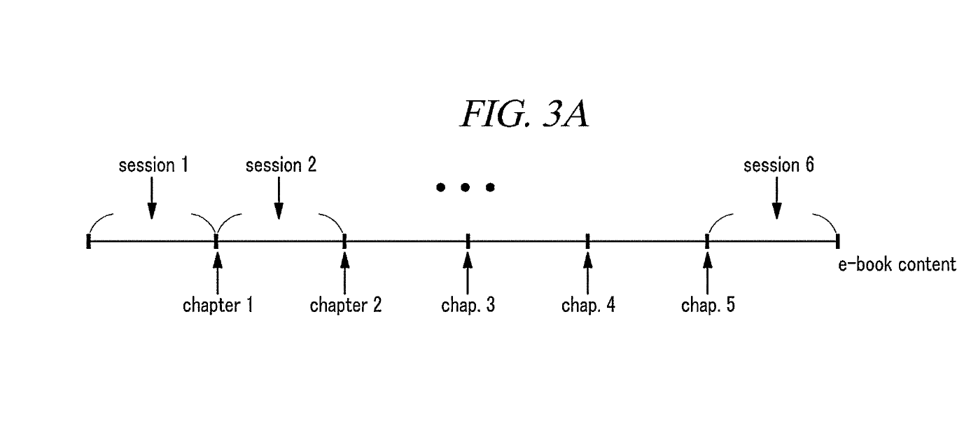

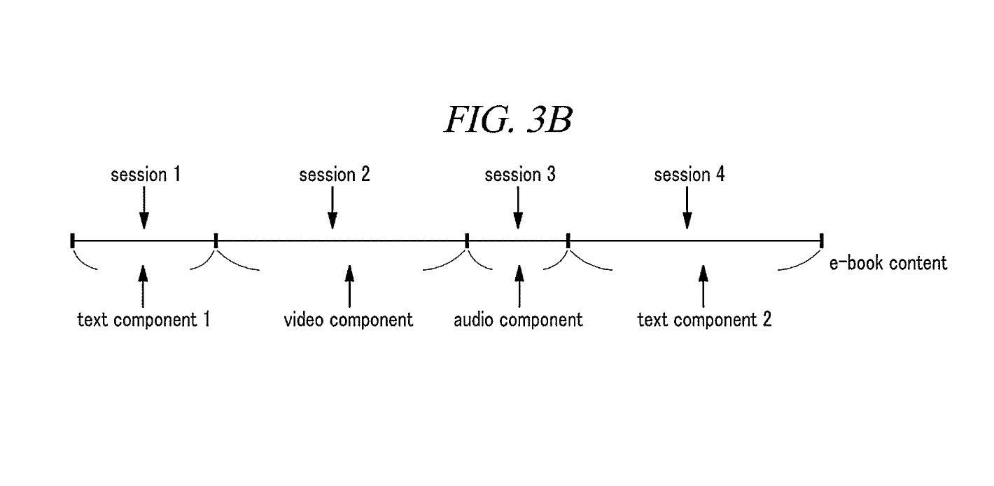

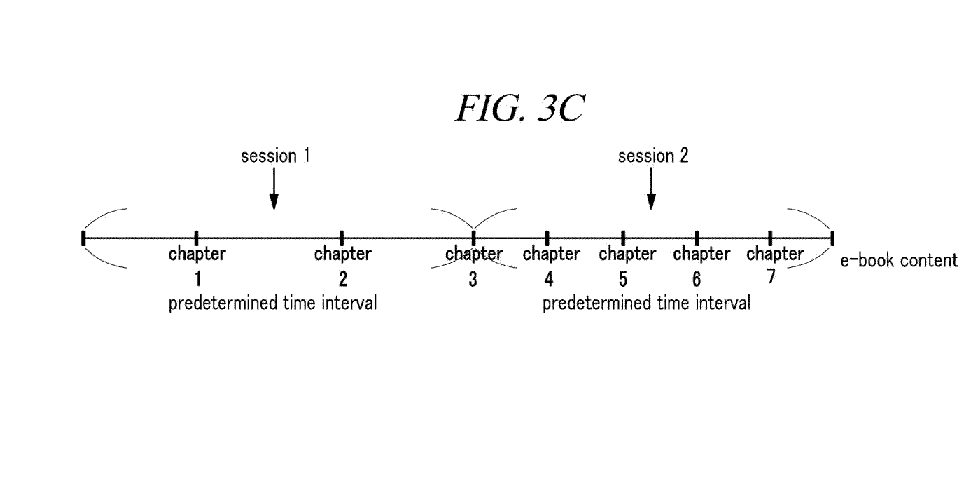

FIG. 3A shows an example timeline that depicts electronic book reading sessions as divided by an electronic book streaming service, in accordance with various embodiments described herein.

In some embodiments, server 120 may be configured to divide electronic book content into multiple reading sessions, based on criteria that included, but are not limited to, an evaluation or analysis of at least one of topical content or chapters of the electronic book content. For example, as depicted in FIG. 3A, server 120 may divide the electronic book content into multiple reading sessions e.g., from session 1 to session 6. Each reading session may include a same predetermined number of chapters. For example, as depicted in FIG. 3A, session 1 may correspond to chapter 1 of the electronic book content, session 2 may correspond to chapter 2 of the electronic book content, and session 6 may correspond to chapter 6 of the electronic book content.

FIG. 3B shows another example timeline that depicts electronic book reading sessions as divided by an electronic book streaming service, in accordance with various embodiments described herein.

In some embodiments, server 120 may be configured to divide electronic book content into multiple reading sessions, based on a playing time of one or more video files, audio files, and/or text files that may be included in the electronic book content. For example, as depicted in FIG. 3B, server 120 may divide the electronic book content into multiple reading sessions e.g., from session 1 to session 4. Session 1 may include a text component 1 that may be displayed by a first text file, session 2 may include a video component that may be displayed by a video file, session 3 may include an audio component that may be displayed by an audio file, and session 4 may include a second text file that may be displayed by a second text file. As depicted in FIG. 3B, the playing time of each of the reading sessions may vary according to a length of the respective video files, audio files, and/or text files that are included in each reading session of the electronic book content.

FIG. 3C shows yet another example timeline that depicts electronic book reading sessions as divided by an electronic book streaming service, in accordance with various embodiments described herein.

In some embodiments, server 120 may be configured to divide electronic book content into multiple reading sessions, so that the playing time of video files and/or audio files included in each of the multiple reading sessions is substantially equal. For example, as depicted in FIG. 3C, server 120 may divide the electronic book content into multiple reading sessions e.g., session 1 and session 2. Session 1 and session 2 may have a same playing time of a predetermined amount of time. Session 1 may include two chapters that, combined, have relatively longer playing time than four chapters that are combined in session 2.

Thus, FIG. 3A shows example timeline that depicts electronic book reading sessions as divided by an electronic book streaming service, in accordance with various embodiments described herein. Further, FIG. 3B shows another example timeline that depicts electronic book reading sessions as divided by an electronic book streaming service, in accordance with various embodiments described herein. Further, FIG. 3C shows yet another example timeline that depicts electronic book reading sessions as divided by an electronic book streaming service, in accordance with various embodiments described herein.

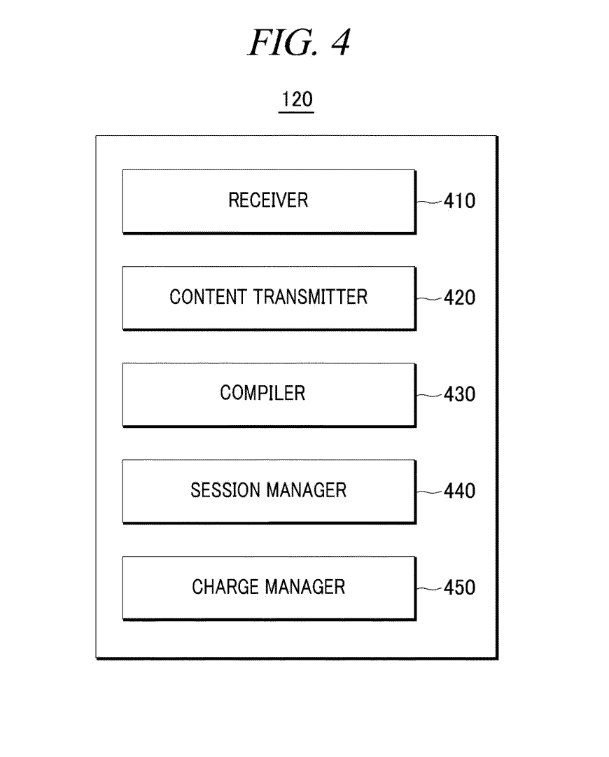

FIG. 4 shows an example server by which at least portions of an electronic book streaming service may be implemented, in accordance with various embodiments described herein. As depicted in FIG. 4, server 120 may include a receiver 410, a content transmitter 420, a compiler 430, a session manager 440, and a charge manager 450. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of receiver 410, content transmitter 420, compiler 430, session manager 440 and charge manager 450 may be included in an instance of an application hosted on server 120.

Receiver 410 may be configured to receive, from end device 110, a request for electronic book content. The electronic book content may include one or more text files and further include at least one of video files, audio files or image files.

Content transmitter 420 may be configured to transmit, to end device 110, the requested electronic book content. In some embodiments, content transmitter 420 may be configured to transmit, to end device 110, a requested reading session of the electronic book content. Content transmitter 420 may stream the reading session of the electronic book content to end device 110. In some embodiments, content transmitter 420 may transmit, to end device 110, e.g., a chapter of the electronic book content as a requested reading session of the electronic book content. Additionally or alternatively, content transmitter 420 may transmit, to end device 110, at least one of the one or more video files, audio files, and/or image files that may be included a reading session of the electronic book content. In some embodiments, content transmitter 420 may determine which files are to be transmitted to end device 110, based on a type of end device 110. For example, content transmitter 420 may be configured to transmit, to end device 110, text files and video files that may be included in a reading session of the electronic book content, if end device 110 is a smart phone which is capable of playing video files.

In some other embodiments, content transmitter 420 may be configured to transmit, to end device 110, at least one of the one or more video files, audio files, and/or image files that may be included a reading session of the electronic book content, based on a user preference. Information regarding the user preference may be pre-learned or pre-registered in server 120 in association with user account authenticated on end device 110. For example, content transmitter 420 may transmit, to end device 110, audio files that may be included in a reading session of the electronic book content when a profile associated with a user account registered on end device 110 indicates a preference to listen to audio files as opposed to reading a text display.

Compiler 430 may be configured to measure a required time for end device 110 to display a page of a text files that may be included in a reading session of the electronic book content. In some embodiments, compiler 430 may receive, from end device 110, time information regarding an amount of time that the text page of the reading session of the electronic book content has been displayed on end device 110. Compiler 430 may further measure the required time from the received time information. In some other embodiments, compiler 430 may count and/or calculate an amount of time for streaming, by content transmitter 420, a text page of the electronic book content, and identify the counted amount of time as the required time.

Compiler 430 may be configured to analyze reading patterns on end device 110, based on the measured required time. In some embodiments, compiler 430 may generate past reading pattern data of end device 110, which may include an average amount of time that a user of end device 110 needs to read a page of the electronic book content. Further, compiler 430 may identify the past reading pattern data as the reading patterns of end device 110.

Session manager 440 may be configured to divide electronic book content into multiple reading sessions, based on criteria that included, but are not limited to, an evaluation or analysis of at least one of topical content or chapters of the electronic book content. For example, session manager 440 may identify and/or determine the number of chapters of the electronic book using known text recognition technologies. Thus, session manager 440 may divide the electronic book content for each of the multiple reading sessions into an equal number of chapters (e.g., each reading session of the electronic book content includes two chapters).

In some other embodiments, session manager 440 may be configured to divide the electronic book content into multiple reading sessions, based on a playing time of one or more video files and/or audio files that may be included in the electronic book content. For example, session manager 440 may divide the electronic book content, so that the playing time of video files and/or audio files included in each of the multiple reading sessions is substantially equal (e.g., the video files and/or audio files in each reading session has a playing time of approximately one minute).

Session manager 440 may be configured to determine a stopping point for a current reading session of the electronic book content on end device 110, based on the past reading pattern data which is included in the reading patterns of end device 110. The current reading session may be a session of the electronic book content that is displayed on end device 110. For example, a reading session of electronic book content that includes video files and/or audio files for romances appropriate for the genre that is expressed to be a preference of the user. When end device 110 requests for a new session that includes video files and/or audio files for humor (e.g., comics or satire) session manager 440 may to stop the reading session (i.e., the session that includes video files or audio files for romance).

In some embodiments, session manager 440 may be configured to determine or predict a stopping point for a reading session of the electronic book content on end device 110, based on playing settings of the video files or audio files that are included in the reading session of the electronic book content. Session manager 440 may stop the current reading session of the electronic book content, when the playing settings of the video files or audio files that correspond to the current reading session change. Session manager 440 may further start another reading session that corresponds to video files or audio files which have the changed playing settings.

For example, the playing settings may include a playing quality or condition of the video files or audio files. The playing quality or condition may include at least one of two-dimensional (2D) video content, three-dimensional (3D) video content, standard definition (SD) video content, high definition (HD) video content, and/or stereo audio content. For example, if a resolution of video files is changed from two-dimensions to three-dimensions, session manager 440 may be configured to stop the reading session which has two-dimensional video files, and to start a new reading session which has three-dimensional video files.

Further, the playing settings of the electronic book content on end device 110 may refer to physical context of end device 110. For example, the physical context of end device 110 may include a type of network 130 or a type of end device 110. Further to the example, if the type of network 130 is changed from 3G to Wi-Fi, session manager 440 may be configured to stop the reading session which has been being transmitted via the 3G network, and to start a new reading session via the Wi-Fi network.

In some embodiments, session manager 440 may be configured to determine or predict a stopping point for a reading session of the electronic book content on end device 110, based on conclusions of at least one of topical content or chapters. For example, when a chapter of the electronic book content to be displayed at end device 110 transitions from one chapter to another chapter, session manager 440 may stop the reading session that corresponds to the current chapter, and start a new reading session that corresponds to the subsequent chapter.

In some embodiments, session manager 440 may be configured to determine a stopping point for a reading session of the electronic book content on end device 110, based on passage of a predetermined time period. Session manager 440 may be configured to maintain the reading session of the electronic book content within the predetermined time period, even if a chapter of the electronic book content to be displayed at end device 110 transits from one chapter to another.

In some embodiments, session manager 440 may be configured to determine a stopping point for a reading session of the electronic book content on end device 110, based on a number of remaining authorized reading sessions for the electronic book content. Session manager 440 may be configured to stop the reading session of the electronic book content on end device 110, if there are no remaining authorized user rights to play the electronic book content.

In some embodiments, session manager 440 may be configured to determine a stopping point for a reading session of the electronic book content on end device 110, based on a current location of end device 110, such as GPS (Global Positioning System) coordinates. Further, for example, session manager 440 may be configured to determine to stop the current reading session of the electronic book content on end device 110, if end device 110 moves to location, e.g., a valley, in which streaming of the electronic book content is limited or unavailable due to a poor network connection.

Charge manager 450 may be configured to charge a fee for the reading session of the electronic book content to a user account associated with the owner and/or operator of end device 110, when the reading session reaches the determined stopping point. In some embodiments, charge manager 450 may monitor a number of remaining authorized reading sessions of the electronic book content that may be associated with the user account associated with the owner and/or operator of end device 110. Further, charge manager 450 may deduct authorized numbers of reading sessions of the electronic book content as for the fee for the reading session.

In some embodiments, charge manager 450 may be configured to charge the fee for the reading session of the electronic book content to another end device when end device 110 received user rights to display the electronic book content from the other end device. For example, if the other end device has user rights to play the electronic book content ten times and if end device 110 received, from the other end device, the user rights to play the electronic book content one time, charge manager 450 may be configured to deduct the user rights of the other end device as for the fee for the reading session of the electronic book content on end device 110.

Thus, FIG. 4 shows an example server by which at least portions of an electronic book streaming service may be implemented, in accordance with various embodiments described herein.

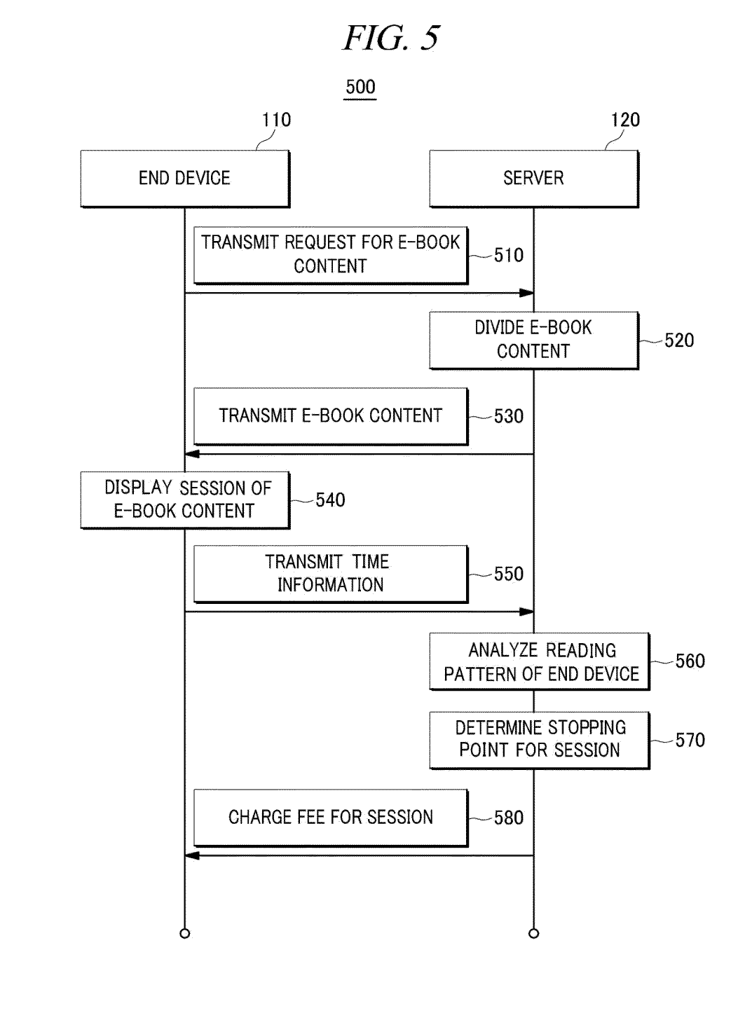

FIG. 5 shows an example processing flow 500 of operations by which at least portions of an electronic book streaming service may be implemented, in accordance with various embodiments described herein. The operations of processing flow 500 may be implemented in system configuration 10 including end device 110 and server 120, as illustrated in FIG. 1. Processing flow 500 may include one or more operations, actions, or functions as illustrated by one or more blocks 510, 520, 530, 540, 550, 560, 570 and/or 580. Although illustrated as discrete blocks, various blocks may be divided into additional blocks, combined into fewer blocks, or eliminated, depending on the desired implementation. Processing may begin at block 510.

Block 510 (Transmit Request for Electronic Book Content) may refer to end device 110 transmitting, to server 120, a request for electronic book content. The electronic book content may include one or more text files and further include at least one of video files, audio files or image files. Processing may proceed from block 510 to block 520.

Block 520 (Dividing Electronic Book Content) may refer to server 120 dividing the electronic book content into multiple reading sessions, based on conclusions of at least one of topical content or chapters of the electronic book content. At block 520, server 120 may identify and/or determine the number of chapters of the electronic book using known text recognition technologies. Thus, server 120 may divide the electronic book content for each of the multiple reading sessions into an equal number of chapters (e.g., each reading session of the electronic book content includes two chapters).

In some embodiments, at block 520, server 120 may divide the electronic book content into multiple reading sessions, based on a playing time of one or more video files and/or audio files that may be included in the electronic book content. For example, server 120 may divide the electronic book content, so that the playing time of video files and/or audio files included in each of the multiple reading sessions is substantially equal (e.g., the video files and/or audio files in each reading session has a playing time of approximately one minute). Processing may proceed from block 520 to block 530.

Block 530 (Transmit Electronic Book Content) may refer to server 120 transmitting, to end device 110, a requested reading session of the electronic book content. Server 120 may stream the reading session of the electronic book content to end device 110. In some embodiments, server 120 may transmit, to end device 110, at least one of the one or more video files, audio files, or image files that may be included the reading session of the electronic book content, based on a type of end device 110. For example, server 120 may transmit, to end device 110, text files and video files that may constitute a reading session of the electronic book content, if end device 110 is a smart phone which is capable of playing video files. For another example, server 120 may transmit, to end device 110, text files and image files that may constitute a reading session of the electronic book content, if end device 110 is a device that is not capable of playing video files. Processing may proceed from block 530 to block 540.

Block 540 (Display Session of Electronic Book Content) may refer to end device 110 displaying the reading session of the electronic book content, which is received at block 530. Processing may proceed from block 540 to block 550.

Block 550 (Transmit Time Information) may refer to end device 110 transmitting, to server 120, time information regarding an amount of time amount that a page of the electronic book content has been displayed on end device 110. Processing may proceed from block 550 to block 560.

Block 560 (Analyze Reading Pattern) may refer to server 120 analyzing reading patterns on end device 110. In some embodiments, at block 560, server 120 may measure a required time for end device 110 to display a page of the electronic book content, based on the time information received at block 550. Further, server 120 may analyze reading patterns on end device 110, based on the measured required time. For example, server 120 may generate past reading pattern data of end device 110, which may include an average time amount for a user of end device 110 to read a page of the electronic book content, from the measured required time. Further, server 120 may identify the past reading pattern data as the reading patterns of end device 110. Further, server 120 may determine or identify that the user of end device 110 has a relatively fast reading speed or a relatively slow reading speed, based on the reading patterns of end device 110. Processing may proceed from block 560 to block 570.

Block 570 (Determine Stopping Point for Session of Electronic Book Content) may refer to server 120 determining a stopping point for the reading session of the electronic book content, which has been displayed on end device 110, based on the past reading pattern data which is included in the reading patterns of end device 110. For example, if the user of end device 110 is determined to have a relatively slow reading speed, server 120 may determine to maintain the reading session of the electronic book content within a predetermined time interval, although a playing of text files that are included in the reading session has ended. For another example, if the user of end device 110 is determined to have a relatively fast reading speed, server 120 may determine to stop the reading session of the electronic book content when a playing of text files that are included in the reading session has ended. Processing may proceed from block 570 to block 580.

Block 580 (Charge Fee for Session of Electronic Book Content) may refer to server 120 charging a fee for the reading session of the electronic book content to a user account associated with the owner and/or operator of end device 110, when the reading session reaches the determined stopping point. In some embodiments, server 120 may deduct authorized numbers of reading sessions of the electronic book content for the fee for the reading session.

Thus, FIG. 5 shows an example processing flow 500 of operations by which at least portions of an electronic book streaming service may be implemented, in accordance with various embodiments described herein.

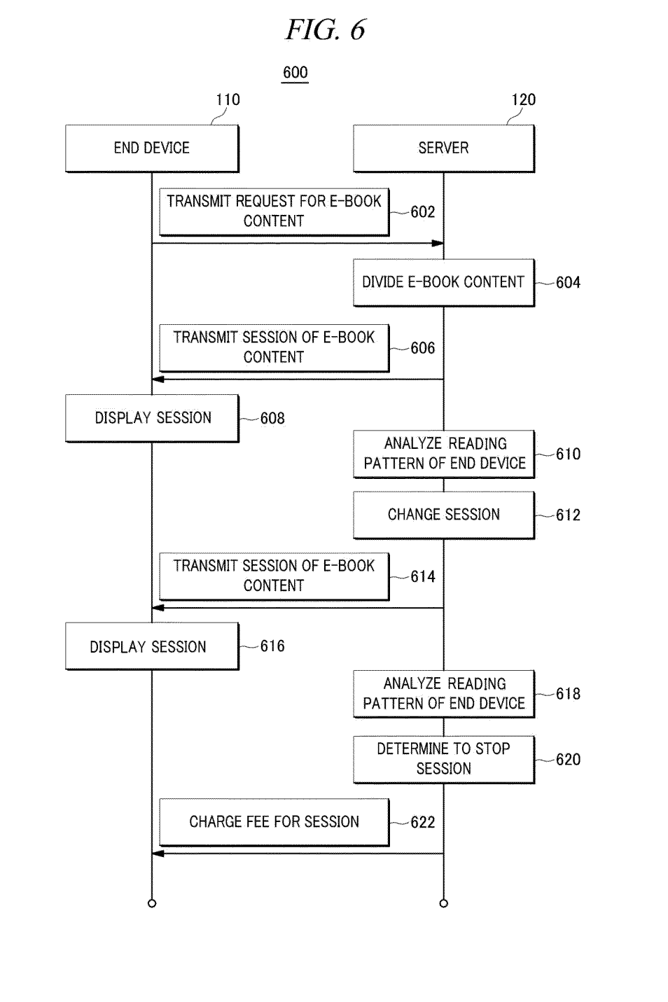

FIG. 6 shows another example processing flow 600 of operations by which at least portions of an electronic book streaming service may be implemented, in accordance with various embodiments described herein. The operations of processing flow 600 may be implemented in system configuration 10 including end device 110 and server 120, as illustrated in FIG. 1. Processing flow 600 may include one or more operations, actions, or functions as illustrated by one or more blocks 602, 604, 606, 608, 610, 612, 614, 616, 618, 620 and/or 622. Although illustrated as discrete blocks, various blocks may be divided into additional blocks, combined into fewer blocks, or eliminated, depending on the desired implementation. Processing may begin at block 602.

Block 602 (Transmit Request for Electronic Book Content) may refer to end device 110 transmitting, to server 120, a request for electronic book content. The electronic book content may include one or more text files and further include at least one of video files, audio files or image files. Processing may proceed from block 602 to block 604.

Block 604 (Dividing Electronic Book Content) may refer to server 120 dividing the electronic book content into multiple reading sessions, based on criteria that included, but are not limited to, an evaluation or analysis of at least one of topical content or chapters of the electronic book content. At block 604, server 120 may identify and/or determine the number of chapters of the electronic book using known text recognition technologies. Thus, server 120 may divide the electronic book content for each of the multiple reading sessions into an equal number of chapters (e.g., each reading session of the electronic book content includes two chapters).

In some embodiments, at block 604, server 120 may divide the electronic book content into multiple reading sessions, based on a playing time of one or more video files and/or audio files that may be included in the electronic book content. For example, server 120 may divide the electronic book content, so that the playing time of video files and/or audio files included in each of the multiple reading sessions is substantially equal (e.g., the video files and/or audio files in each reading session has a playing time of approximately one minute). Processing may proceed from block 604 to block 606.

Block 606 (Transmit Session of Electronic Book Content) may refer to server 120 transmitting, to end device 110, a first reading session of the requested electronic book content. Server 120 may stream the first reading session of the electronic book content to end device 110. In some embodiments, server 120 may transmit, to end device 110, at least one of the one or more video files, audio files, or image files that may be included in the first reading session of the electronic book content. Processing may proceed from block 606 to block 608.

Block 608 (Display Session of Electronic Book Content) may refer to end device 110 displaying the first reading session of the electronic book content, which is received at block 606. Processing may proceed from block 608 to block 610.

Block 610 (Analyze Reading Pattern) may refer to server 120 analyzing reading patterns on end device 110. In some embodiments, at block 610, server 120 may measure a required time for end device 110 to display a page of the electronic book content by counting an amount of time for streaming a page of the first reading session of the electronic book content. Further, server 120 may identify the counted amount of time as the required time. Further, server 120 may analyze the reading patterns on end device 110, based on the measured required time. Processing may proceed from block 610 to block 612.

Block 612 (Change Session of Electronic Book Content) may refer to server 120 changing a reading session of the electronic book content. In some embodiments, server 120 may determine a stopping point for the first reading session of the electronic book content on end device 110, based on playing settings of the video files and/or audio files that may be included in the first reading session of the electronic book content. Server 120 may stop to stream the first reading session of the electronic book content, when the playing settings of the video files or audio files that correspond to the first reading session changes.

For example, the playing settings may include a playing quality or condition of the video files or audio files that are included in the first reading session. The playing quality or condition may include at least one of two-dimensional (2D), three-dimensional (3D), standard definition (SD), high definition (HD) or stereo. For example, if a resolution of video files is changed from 2D to 3D, server 120 may stop the first reading session which has two-dimensional video files. Processing may proceed from block 612 to block 614.

Block 614 (Transmit Session of Electronic Book Content) may refer to server 120 transmitting, to end device 110, another reading session that corresponds to video files or audio files which have the changed playing settings. In accordance with the above example, server 120 may start to stream a second reading session which has three-dimensional video files to end device 110. Processing may proceed from block 614 to block 616.

Block 616 (Display Session of Electronic Book Content) may refer to end device 110 displaying the second session of the electronic book content, which is received at block 614. Processing may proceed from block 616 to block 618.

Block 618 (Analyze Reading Pattern) may refer to server 120 analyzing reading patterns on end device 110. In some embodiments, at block 618, server 120 may measure a required time for end device 110 to display a page of the electronic book content by counting an amount of time for streaming a page of the second reading session of the electronic book content. Processing may proceed from block 618 to block 620.

Block 620 (Determine to Stop Session of Electronic Book Content) may refer to server 120 determining to stop the second reading session of the electronic book content. In some embodiments, server 120 may determine to stop to stream the second reading session of the electronic book content on end device 110, based on conclusions of at least one of topical content or chapters. For example, if a chapter of the electronic book content to be displayed at end device 110 transits from one chapter to another, server 120 may be configured to stop the second reading session which corresponds to the chapter. Processing may proceed from block 620 to block 622.

Block 622 (Charge Fee for Session of Electronic Book Content) may refer to server 120 charging a fee for the first reading session and the second reading session of the electronic book content to a user account associated with the owner and/or operator of end device 110, which are displayed on end device 110. In some embodiments, server 120 may deduct authorized numbers of sessions of the electronic book content for the fee for the first session and the second session of the electronic book content.

Thus, FIG. 6 shows another example processing flow 600 of operations by which at least portions of an electronic book streaming service may be implemented, in accordance with various embodiments described herein.

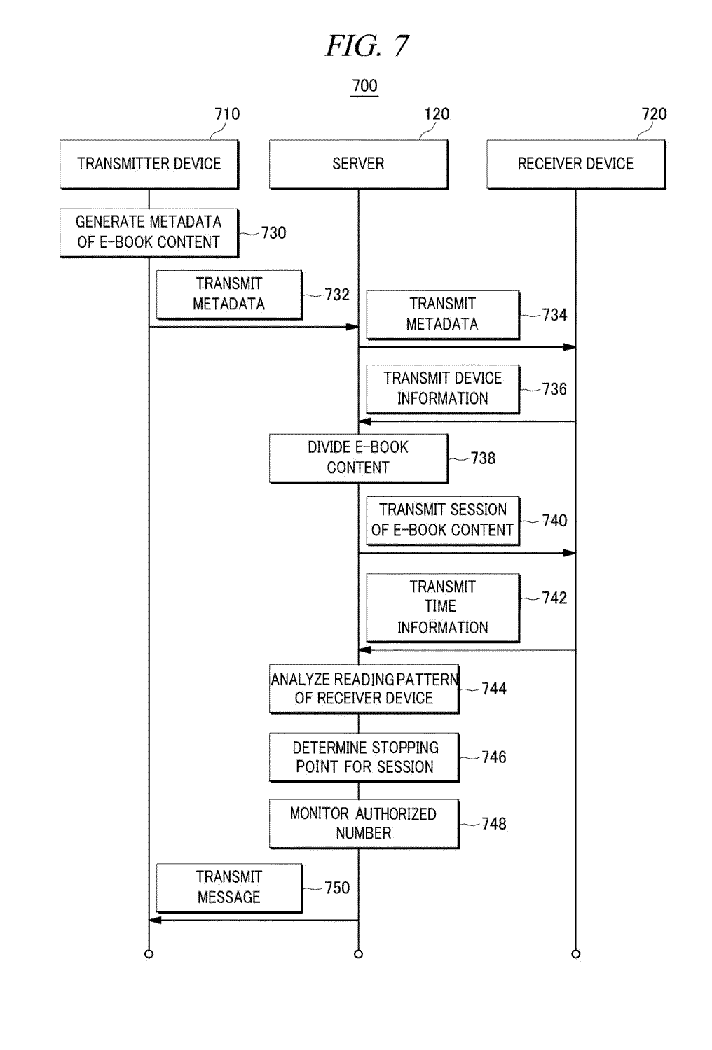

FIG. 7 shows yet another example processing flow 700 of operations by which at least portions of an electronic book streaming service may be implemented, in accordance with various embodiments described herein. The operations of processing flow 700 may be implemented by a transmitter device 710, server 120, and receiver device 720. Respective one of transmitter device 710 and receiver device 720 may include end device 110 which is illustrated in FIG. 1. Processing flow 700 may include one or more operations, actions, or functions as illustrated by one or more blocks 730, 732, 734, 736, 738, 740, 742, 744, 746, 748 and/or 750. Although illustrated as discrete blocks, various blocks may be divided into additional blocks, combined into fewer blocks, or eliminated, depending on the desired implementation. Processing may begin at block 730.

Block 730 (Generate Metadata of Electronic Book Content) may refer to transmitter device 710 generating metadata of electronic book content. In some embodiments, transmitter device 710 may generate the metadata of the electronic book content that a user of transmitter device 710 intends to recommend to receiver device 720. For example, the metadata of the electronic book content may include at least one of a title, an author (or a writer) or a genre of the electronic book content. Processing may proceed from block 730 to block 732.

Block 732 (Transmit Metadata of Electronic Book Content) may refer to transmitter device 710 transmitting, to server 120, the metadata of the electronic book content, which is generated at block 730. Processing may proceed from block 732 to block 734.

Block 734 (Transmit Metadata of Electronic Book Content) may refer to server 120 transmitting, to receiver device 720, metadata of the electronic book content. At block 734, server 120 may search and find the electronic book content from a database, based on the at least one of a title, an author (or a writer) or a genre of the electronic book content. Further, server 120 may transmit, to receiver device 720, metadata that may include a list of chapters of the electronic book content. Processing may proceed from block 734 to block 736.

Block 736 (Transmit Device Information) may refer to receiver device 720 transmitting device information to server 120. For example, the device information may include physical context of receiver device 720. For example, the physical context of receiver device 720 may include a type of a network that is coupled to receiver device 720, a type of receiver device 720 or a current location of receiver device 720, such as GPS coordinates. Processing may proceed from block 736 to block 738.

Block 738 (Divide Electronic Book Content) may refer to server 120 dividing the electronic book content into multiple reading sessions, based on criteria that included, but are not limited to, an evaluation or analysis of at least one of topical content or chapters of the electronic book content. At block 738, server 120 may identify and/or determine the number of chapters of the electronic book using known text recognition technologies. Thus, server 120 may divide the electronic book content for each of the multiple reading sessions into an equal number of chapters (e.g., each reading session of the electronic book content includes two chapters).

In some embodiments, at block 738, server 120 may divide the electronic book content into multiple reading sessions, based on a playing time of one or more video files and/or audio files that may be included in the electronic book content. For example, server 120 may divide the electronic book content, so that the playing time of video files and/or audio files included in each of the multiple reading sessions is substantially equal (e.g., the video files and/or audio files in each reading session has a playing time of approximately one minute). Processing may proceed from block 738 to block 740. Processing may proceed from block 738 to block 740.

Block 740 (Transmit Session of Electronic Book Content) may refer to server 120 transmitting, to receiver device 720, a reading session of the electronic book content. Server 120 may stream the reading session of the electronic book content to receiver device 720. In some embodiments, server 120 may transmit, to receiver device 720, at least one of the one or more video files, audio files, or image files that may constitute the reading session of the electronic book content, based on the device information of receiver device 720. For example, server 120 may transmit, to receiver device 720, text files and video files that may be included a reading session of the electronic book content, if receiver device 720 is a smart phone that is capable of playing video files. As another example, server 120 may transmit, to end device 110, text files and image files that may be included a reading session of the electronic book content, if receiver device 720 is a device that is not capable of playing video files. Processing may proceed from block 740 to block 742.

Block 742 (Transmit Time Information) may refer to receiver device 720 transmitting, to server 120, time information regarding an amount of time for a page of the electronic book content has been displayed on receiver device 720. Processing may proceed from block 742 to block 744.

Block 744 (Analyze Reading Pattern) may refer to server 120 analyzing reading patterns on receiver device 720. In some embodiments, at block 744, server 120 may measure a required time for receiver device 720 to display a page of the electronic book content, based on the time information received at block 742. Further, server 120 may analyze reading patterns on receiver device 720, based on the measured required time. For example, server 120 may generate past reading pattern data of receiver device 720, which may include an average time amount for a user of receiver device 720 to read a page of the electronic book content, from the measured required time. Further, server 120 may identify the past reading pattern data as the reading patterns of receiver device 720. Further, server 120 may determine or identify that the user of receiver device 720 has a relatively fast reading speed or a relatively slow reading speed, based on the reading patterns of receiver device 720. Processing may proceed from block 744 to block 746.

Block 746 (Determine Stopping Point for Session of Electronic Book Content) may refer to server 120 determining a stopping point for the reading session of the electronic book content, which has been displayed on receiver device 720, based on the past reading pattern data which is included in the reading patterns of receiver device 720. For example, if the user of receiver device 720 is determined to have a relatively slow reading speed, server 120 may determine to maintain the reading session of the electronic book content within a predetermined time period, although a playing of text files that are included in the reading session has ended. For another example, if the user of receiver device 720 is determined to have a relatively fast reading speed, server 120 may determine to stop the reading session of the electronic book content when a playing of text files that are included in the reading session has ended. Processing may proceed from block 746 to block 748.

Block 748 (Monitor Authorized Number) may refer to server 120 monitoring a number of remaining authorized reading sessions of the electronic book content for transmitter device 710. Further, server 120 may deduct authorized number of reading sessions of the electronic book content as for a fee for the reading session. Processing may proceed from block 748 to block 750.

Block 750 (Transmit Message) may refer to server 120 transmitting, to transmitter device 710, a message that indicates that the authorized number of reading sessions of the electronic book content of transmitter device 710 is deducted as for the fee for the reading session.

Thus, FIG. 7 shows still another example processing flow 700 of operations by which at least portions of an electronic book streaming service may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

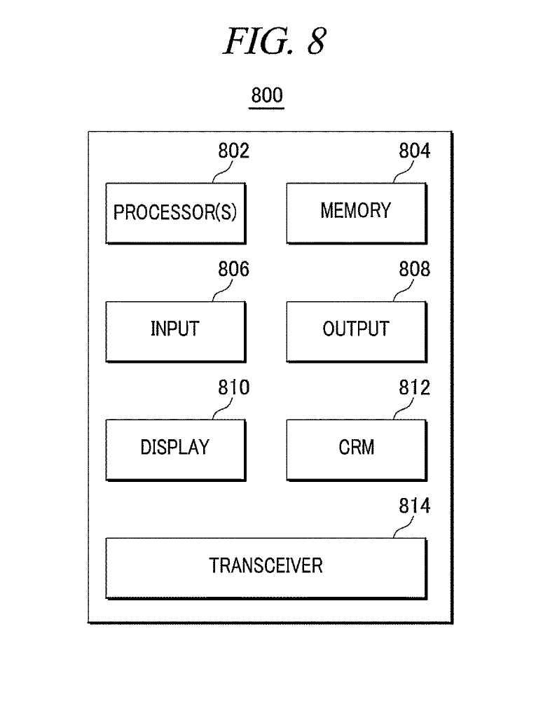

FIG. 8 shows an illustrative computing embodiment, in which any of the processes and sub-processes of an electronic book streaming service may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 800 may typically include, at least, one or more processors 802, a system memory 804, one or more input components 806, one or more output components 808, a display component 810, a computer-readable medium 812, and a transceiver 814.

Processor 802 may refer to, e.g., a microprocessor, a microcontroller, a digital signal processor, or any combination thereof.

Memory 804 may refer to, e.g., a volatile memory, non-volatile memory, or any combination thereof. Memory 804 may store, therein, an operating system, an application, and/or program data. That is, memory 804 may store executable instructions to implement any of the functions or operations described above and, therefore, memory 804 may be regarded as a computer-readable medium.

Input component 806 may refer to a built-in or communicatively coupled keyboard, touch screen, or telecommunication device. Alternatively, input component 806 may include a microphone that is configured, in cooperation with a voice-recognition program that may be stored in memory 804, to receive voice commands from a user of computing device 800. Further, input component 806, if not built-in to computing device 800, may be communicatively coupled thereto via short-range communication protocols including, but not limitation, radio frequency or Bluetooth.

Output component 808 may refer to a component or module, built-in or removable from computing device 800, that is configured to output commands and data to an external device.

Display component 810 may refer to, e.g., a solid state display that may have touch input capabilities. That is, display component 810 may include capabilities that may be shared with or replace those of input component 806.

Computer-readable medium 812 may refer to a separable machine readable medium that is configured to store one or more programs that embody any of the functions or operations described above. That is, computer-readable medium 812, which may be received into or otherwise connected to a drive component of computing device 800, may store executable instructions to implement any of the functions or operations described above. These instructions may be complimentary or otherwise independent of those stored by memory 804.

Transceiver 814 may refer to a network communication link for computing device 800, configured as a wired network or direct-wired connection. Alternatively, transceiver 814 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A server, comprising:
a content transmitter configured to transmit e-book content to an end device that displays e-book content;
a compiler configured to analyze e-book reading patterns on the end device;
a session manager configured to:
divide the e-book content into a plurality of reading sessions, and
determine a stopping point for a current one of the reading sessions, based on past reading pattern data included in the reading patterns of the end device; and
a charge manager configured to charge a fee for the current reading session, when the current reading session reaches the determined stopping point.

2. The server of claim 1, wherein the e-book content includes at least one of one or more video files, audio files, or image files.

3. The server of claim 2, wherein the content transmitter is configured to transmit, to the end device, at least one of the one or more video files, audio files, or image files, based on a type of the end device.

4. The server of claim 2, wherein the content transmitter is configured to transmit, to the end device, at least one of the one or more video files, audio files, or image files, based on a user preference.

5. The server of claim 1, wherein the content transmitter is configured to stream the current reading session of the e-book content to the end device.

6. The server of claim 1, wherein the session manager is configured to divide the e-book content into the plurality of reading sessions, based on conclusions of at least one of topical content or chapters.

7. The server of claim 1, wherein the session manager is configured to divide the e-book content into the plurality of reading sessions, based on play time of one or more video files or audio files included in the e-book content.

8. The server of claim 7, wherein the charge manager is further configured to determine the fee for the current reading session, based on playing settings of the video files or audio files.

9. The server of claim 8, wherein the session manager is further configured to:
stop the current reading session, when the playing settings of the video files or audio files that correspond to the current reading session changes, and
start another reading session that corresponds to the video files or audio files having the changed playing settings.

10. The server of claim 1, wherein the session manager is configured to determine the stopping point for the current reading session of the e-book content, further based on at least one of a type of a network between the server and the end device or a type of the end device.

11. The server of claim 1, wherein the session manager is configured to maintain the current reading session within a predetermined time interval.

12. The server of claim 11, wherein the session manager is configured to maintain the current reading session, when a chapter of the e-book content to be displayed at the end device transits from one chapter to another chapter within the predetermined time interval.

13. The server of claim 1, wherein the compiler is configured to measure a required time for the end device to display a page of the e-book content,
wherein the compiler is configured to analyze the reading patterns on the end device, based on the measured required time.

14. The server of claim 1, wherein the charge manager is configured to monitor a number of remaining authorized number of the plurality of reading sessions of the e-book content.

15. The server of claim 1, wherein the charge manager is configured to charge the fee for the current reading session to another end device, when the end device received user rights to display the e-book content from the other end device.

16. A method performed under control of a server, comprising:
dividing e-book content into a plurality of reading sessions;
transmitting, to an end device that displays e-book content, e-book content for a requested one of the plurality of reading sessions;
analyzing reading patterns on the end device;
determining a stopping point for the requested reading session on the end device, based on past reading pattern data included in the reading patterns of the end device; and
charging a fee for the requested reading session, when the requested reading session reaches the determined stopping point.

17. The method of claim 16, further comprising:
measuring a required time for the end device to display a page of the e-book content,
wherein the analyzing of the reading patterns of the end device is based on the measured required time.

18. The method of claim 16, wherein the e-book content includes at least one of one or more video files, audio files, or image files,
wherein the method further comprises:
transmitting, to the end device, at least one of the one or more video files, audio files, or image files, based on a type of the end device.

19. The method of claim 16, wherein the dividing of the e-book content is based on at least one of conclusions of chapters of the e-book content or play time of one or more video files or audio files included in the e-book content.

20. A computer-readable storage medium having thereon computer-executable instructions that, in response to execution, cause a server to perform operations, comprising:
dividing e-book content into a plurality of reading sessions;
transmitting, to an end device that displays the e-book content, e-book content for a requested one of the plurality of reading sessions;
analyzing reading patterns on the end device;
determining a stopping point for the requested reading session, based on past reading pattern data included in the reading patterns of the end device; and
charging a fee for the requested reading session, when the requested reading session reaches the determined stopping point.
